(19) United States
(12) Patent Application Publication
(10) Pub. No.: US 2009/0299932 A1
(43) Pub. Date: Dec. 3, 2009

(54) System and method for providing a virtual persona

(75) Inventors: Peter G. Hodge, Boca Raton, FL (US); Stuart G. Hodge, Ottawa (CA); Simon R. Edwards, Melbourne (AU)

Correspondence Address: CARR & FERRELL LLP, 2200 GENG ROAD, PALO ALTO, CA, 94303, US

(73) Assignee: Virsona Inc.

(21) Appl. No.: 12/154,881

(22) Filed: May 27, 2008

(51) Int. Cl. G06N 5/00

(52) U.S. Cl. 706/45

(57) ABSTRACT

A method, system, and machine readable medium for providing a virtual persona are disclosed. User input directed to a life archive data of a particular virtual persona is received. One or more artificial intelligence files are determined in response to the user input. An output may be generated based on the one or more artificial intelligence files and provided to the user.

### BACKGROUND

1. Field of the Invention

The present invention relates generally to artificial intelligence and social networking, and more specifically, to creating virtual personas.

2. Background Art

Avatars are used as a representation of a person. The avatar may be in the form of a three-dimensional model or a two-dimensional icon used on Internet forums and other on-line communities. Typically, the avatar is an object representing an embodiment of a user. In Yahoo! Messenger, for example, users may create avatars having a unique human appearance to provide a graphical representation of the user to other users.

Disadvantageously, the avatar is limited to being only a graphical representation of the user, which acts and responds at the direction of the user. The avatar cannot act independently from the user when prompted by other individuals.

Typically, individuals maintain data about one's life. The data may be stored in the form of digital photos, diaries, blogs, etc. The individuals may then revisit and review their stored data. Conventionally, this may entail searching for particular data using a search engine or by manually reviewing data files. This process may be tedious, time consuming, and frustrating. As such, it would be desirable to enable an intelligent and interactive representation which can provide responses to a user's inquiries.

### SUMMARY

Embodiments of the present invention provide exemplary systems and methods for providing a virtual persona. In exemplary embodiments, a user input directed to life archive data of a particular virtual persona is received by a virtual persona system. The user input may be a question directed to a virtual persona.

One or more artificial intelligence (AI) files may be reviewed to determine a response to the user input. The AI files comprise a listing of questions and potential answers generated based on tags or metatags assigned to life archive data entries. In exemplary embodiments, life archive data entries may be received by the virtual persona system. These life archive data entries may then be tagged with one or more keywords identified within the data entry. The tagged data entries are then processed to generate AI files, whereby the questions are associated with the tagged keywords.

The response to the user input may be based on one or more AI files determined to contain keywords associated with the user input. If more than one response from one or more AI files are identified, the virtual persona system may weigh the responses to select one or more of the responses. An output may be generated based on the one or more responses and provided to the user.

### BRIEF DESCRIPTION OF THE DRAWINGS

FIG. 1 is a block diagram of an exemplary environment in which embodiments of the present invention may be practiced.

FIG. 2 is a block diagram of an exemplary virtual persona system.

FIG. 3 is a block diagram of an exemplary data capture engine.

FIG. 4 is a block diagram of an exemplary artificial intelligence engine.

FIG. 5 is a flowchart of a method for providing a virtual persona in accordance with one embodiment.

FIG. 6 is a flowchart of an exemplary method for generating a virtual persona output.

FIG. 7 illustrates an exemplary communication device or system.

### DETAILED DESCRIPTION OF EXEMPLARY EMBODIMENTS

The present invention provides exemplary methods, systems, and machine readable mediums for providing a virtual persona. The virtual persona comprises an interactive and responsive virtual portrayal of an individual. The virtual persona may be private (e.g., one's own persona) or public (e.g., a persona anyone can interact with such as a historical figure). The interactions provided by the virtual persona may comprise responses to questions presented by a user whereby the responses are based on an archive associated with the life of the virtual persona.

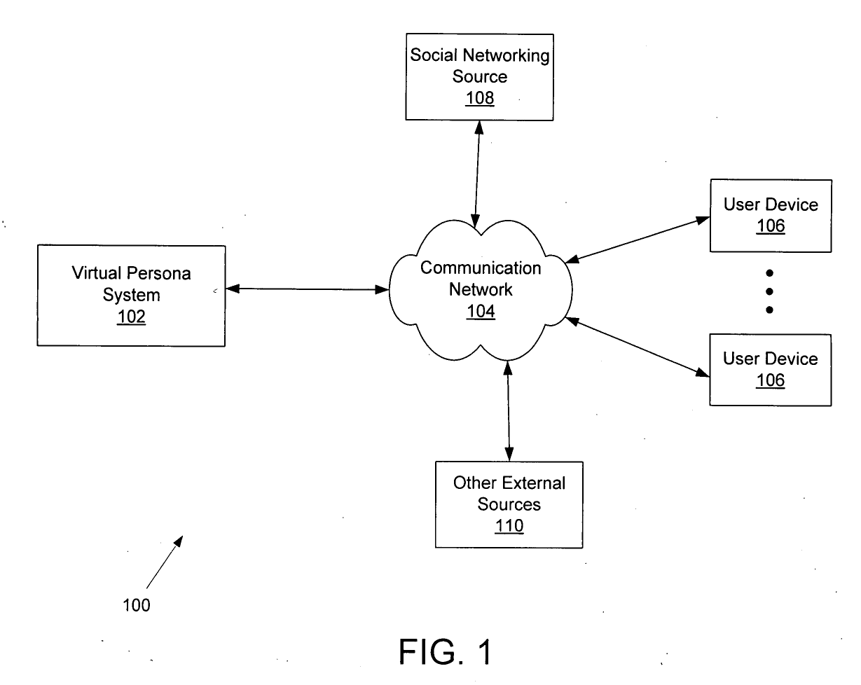

Referring now to FIG. 1, a block diagram of an exemplary environment 100 in which embodiment of the present invention may be practiced is shown. In exemplary embodiments, a virtual persona system 102 is coupled via a communication network 104 with one or more user devices 106. Each user devices 106 may be associated with one or more users. The user devices 106 may be used by the user to interact with the virtual persona system 102. Such interaction may include inputting life archive data, modifying the user's virtual persona settings, and interaction with a virtual persona.

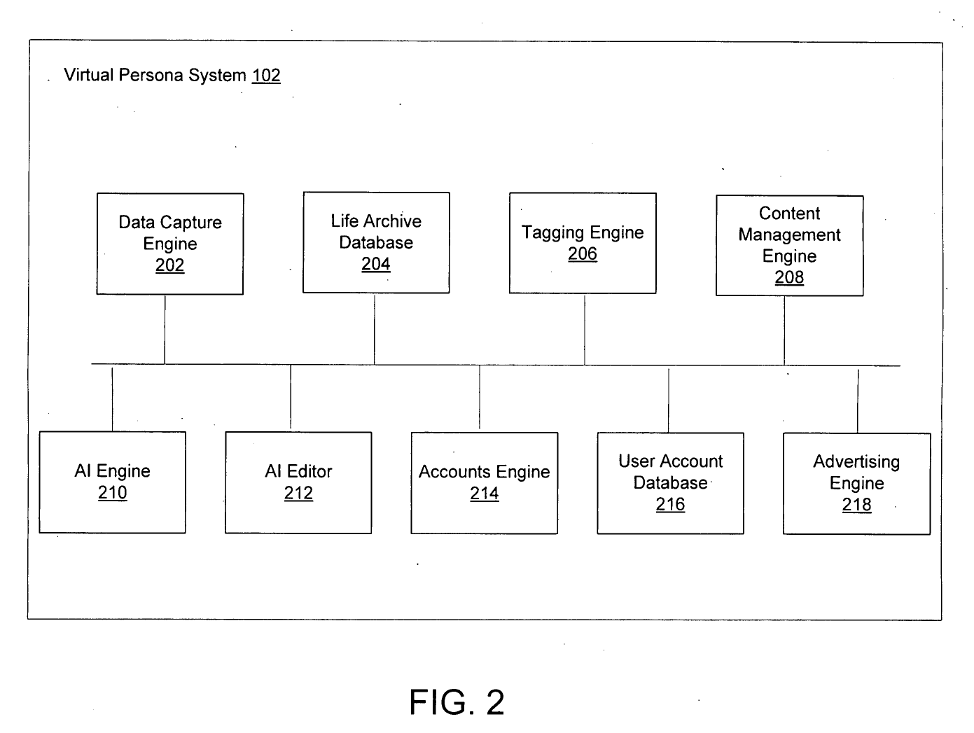

The virtual persona system 102 is configured to provide a virtual persona of an individual. The individual may comprise a real person, an imaginary person, or a historical person. In some embodiments, the individual may comprise the user associated with the user device 106 requesting interaction with the virtual persona. In exemplary embodiments, the life archive data for a virtual persona and the settings of a virtual persona may be managed utilizing the virtual persona system 102. The virtual persona system 102 will be discussed in more detail in connection with FIG. 2.

The user devices 106 may access the virtual persona system 102 via the network 104 or directly. For example, the network 104 may comprise the Internet, an intranet, a peer to peer network, or any other type of network. The user devices 106 may comprise any type of digital devices, such as a laptop or desktop computer, a cellular telephone, a personal digital assistant (PDA), and so forth. Similarly, the virtual persona system 102 may comprise any type of digital device according to exemplary embodiments.

The virtual persona system 102 may also be coupled via the network 104 to one or more social networking sources 108 and/or other external sources 110. The social networking sources 108 may be any social networking website or source. Some examples of social networking sources 108 include Facebook, MySpace, and Friendster. These social networking sources 108 may be used to provide life archive data to the virtual persona system 102.

Other external sources 110 may also be used to provide life archive data to the virtual persona system 102. In one embodiment, these external sources 110 may comprise commercial sites the user interacts with. Examples of the other external sources 110 may include sources such as iTunes, Amazon, and NetFlix. In some embodiments, these external sources 110 provided interaction information, such as purchases and browsing history, to the virtual persona system 102.

It should be noted that FIG. 1 is exemplary. Alternative embodiments may comprise any number of virtual persona systems 102, user devices 106, and sources and still be within the scope of exemplary embodiments.

Referring now to FIG. 2, a block diagram of the exemplary virtual persona system 102 is illustrated. In exemplary embodiments, the virtual persona system 102 may comprise a data capture engine 202, a life archive database 204, a tagging engine 206, a content management engine 208, an artificial intelligence (AI) engine 210, an AI editor 212, an accounts engine 214, and a user account database 216.

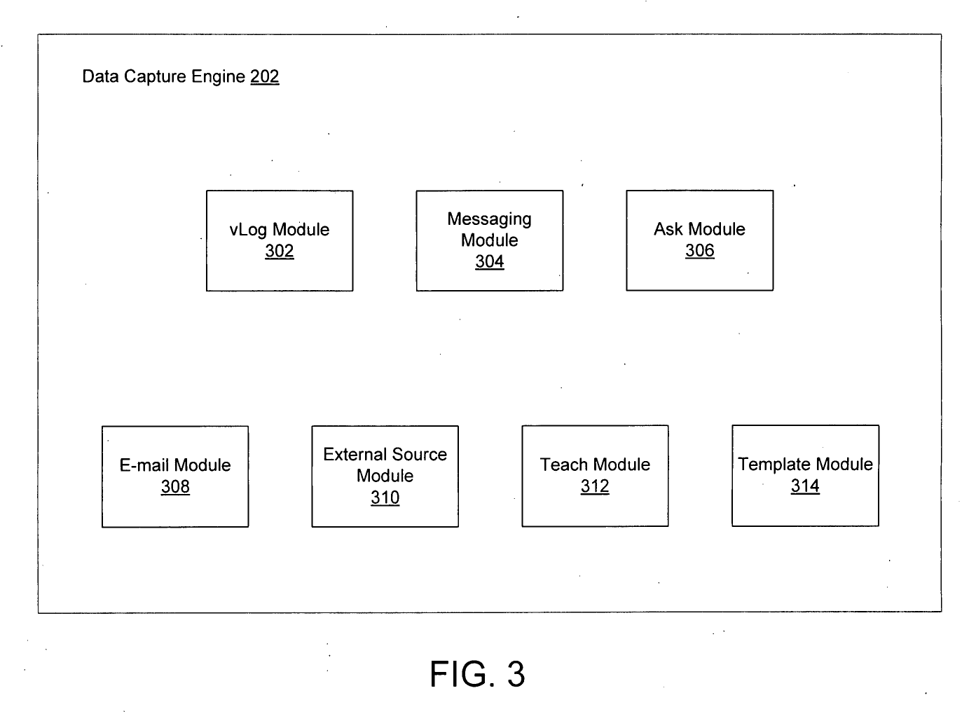

The exemplary data capture engine 202 is configured to receive life archive data entries used by the virtual persona system 102 to generate the virtual persona. The data capture engine 202 may capture data from any source coupled to the virtual persona system 102, such as the user devices 106, social networking sources 108, and other external sources 110. The data capture engine 202 stores the data entries in the life archive database 204. Examples of data entries include blogs, emails, and instant messaging conversations. The data capture engine 202 will be discussed in more detail in connection with FIG. 3.

The exemplary tagging engine 206 is configured to tag the life archive data entries stored in the life database 204. The tagging may occur as the data entry is received into the life database 204, at regularly scheduled intervals (e.g., every minute), or at any time the tagging engine 206 is directed to do so (e.g., manual instructions). In exemplary embodiments, the tagging engine 206 analyzes each data entry for keywords which may be associated with tags (or metatags).

In exemplary embodiments, the tagging engine 206 uses one or more lookup tables. For example, one table may contain a list of noun keywords and another table may contain a list of verb keywords. Other tables comprising other key items (e.g., adjectives, proper names) may also be utilized. Thus, any number of lookup tables associated with key items may be utilized in various embodiments of the present invention. The tagging engine 206 is configured to search each data entry for keywords from the one or more lookup tables. The tagging engine 206 may determine which keywords are to be tags for the particular data entry. For example, assume the data entry is a blog about table tennis. During a next tagging cycle, the tagging engine 206 assesses which keywords from the lookup tables are in the blog. The tagging engine 206 may also determines which keywords are to be tags for the blog. In one embodiment, the tags are the keywords used most often. For this example, assume the keywords “table,” “tennis,” and “play” are among the most used keywords in the blog. As such, the tagging engine 206 may determine that the words “table,” “tennis,” and “play” are the tags or metatags for this data entry.

After the data entry is tagged, the data entry may be flagged as having been tagged. As a result, the next time the tagging engine 206 goes through the data entries in the life database 204, the tagging engine 206 will skip any data entry that has already been flagged. This allows the virtual persona system 102 to prevent redundant tagging.

In some embodiments, the flag may be removed from one or more data entries if there is a desire to retag these data entries. The tagging engine 206 may then retag these data entries in a next tagging cycle. The flags on all data entries associated with one or more virtual personas or individuals may also be removed if there is a desire to retag all data entries associated with these virtual personas or individuals in the life database 204. For example, if the lookup table has been updated or the algorithm for determining keywords has been modified, it may be desirable to retag every data entry in the life archive database 204.

The exemplary content management engine 208 is configured to manage data stored in the life archive database 204. In exemplary embodiments, data entries captured by the data capture engine 202 may be associated with a particular individual or virtual persona by the content management engine 208 and archived accordingly. The content management engine 208 may also track which data entries, tags, and AI files (which will be discussed in more details below) belong to each virtual persona. Furthermore, when a user logs into the virtual persona system 102, the content management engine 208 may notify the AI engine 210 to load AI files for the requested virtual persona. Having the AI files loaded (e.g., into memory) allows for quicker searching when interacting with the virtual persona.

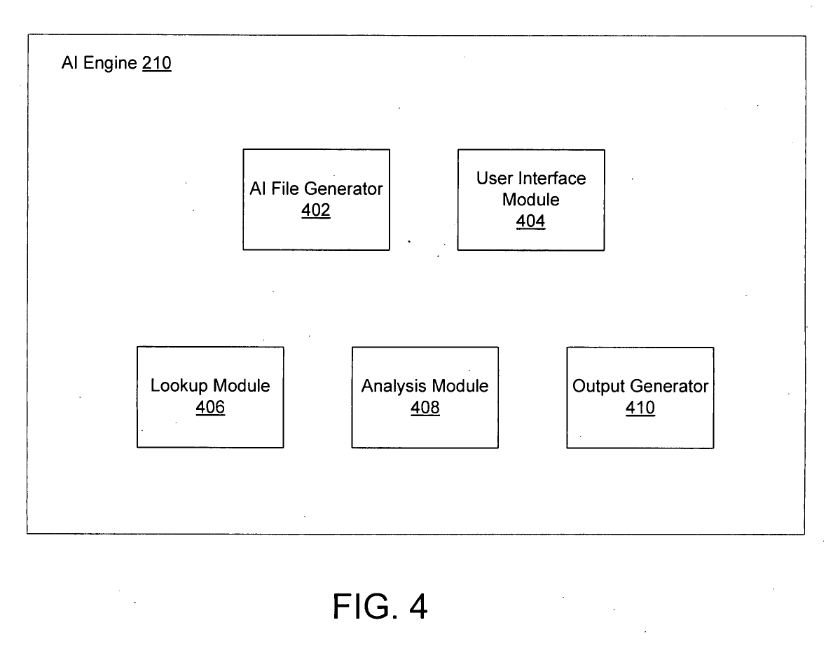

The AI engine 210 manages the interactions between the user and a virtual persona. In exemplary embodiments, the AI engine 210 is configured to generate the AI files. Furthermore, the AI engine 210 may receive communications from the user (i.e., user inputs such as questions) and provides responses (e.g., answers) as a virtual persona based on the AI files. The AI engine 210 will be discussed in more detail in connection with FIG. 4 below.

The exemplary AI editor 212 allows a user to directly modify the AI files. Directly modifying the AI files is a method by which the user may modify their virtual persona by providing an answer different from the answer provided by one or more AI files. In various embodiments, the user may directly modify their private AI files (e.g., files associated with a particular private virtual persona), community AI files (e.g., files with inputs from a plurality of users), or generic AI files (e.g., files with generic information common to most/all users) if authorized to do so. In one embodiment, the AI editor 212 provides a graphic user interface for the user to modify the AI file.

The exemplary accounts engine 214 manages user accounts with the virtual persona system 102. In exemplary embodiments, the accounts engine 214 may provide account setup, account maintenance, and password management. Additionally, the accounts engine 214 may handle customer billing.

In some embodiments, the accounts engine 214 may also manage access to a virtual persona. For example, a user may elect to make their virtual persona public, private, or private with access rights. While a public virtual persona may be accessed by anyone, a private virtual persona can only be accessed by the user associated with the private virtual persona. However, the private virtual persona with access rights allows access to a private virtual persona to an individual granted permission to access the private virtual persona. For example, user A may invite user B to communicate with user A's virtual persona. User B will be allowed to interact with user A's virtual persona, but will not be able to change any answers associated with user A's virtual persona (e.g., change the associate AI files).

In exemplary embodiments, when a user logs in or otherwise indicates a virtual persona with which to interact, the AI files for the particular virtual persona may be loaded into memory. By loading the AI files for the particular virtual persona, responses may be determined and return faster. In one embodiment, the accounts engine 214 may verify the login and access privileges. Subsequently, the content management engine 208 may determine which AI files should be loaded and send instructions to do so.

The user account database 216 stores user account information. For example, the account database 214 stores the user's username, password, membership type, membership terms, premium service subscriptions, payment and billing information, and other administrative information about the user's account. The user account database 216 may also store access rights to private virtual personas.

An advertising engine 218 may be provided to interact with the AI engine 210 and the data capture engine 202 to provide relevant advertisements during interactions with the virtual personas. The advertising engine 218 may also manages a flow of advertisements during the interactions with the virtual personas.

It should be noted that the embodiment of FIG. 2 is exemplary. Alternative embodiments may comprise more, less, or functionally equivalent combination of components and still be within the scope of exemplary embodiments.

Referring now to FIG. 3, a block diagram of the exemplary data capture engine 202 is illustrated. The exemplary data capture engine 202 provides various modules that allow users to populate life archives. The data capture engine 202 may comprise a vLog module 302, a messaging module 304, an ask module 306, an e-mail module 308, an external source module 310, and a teach module 312. Alternative embodiments may comprise more, less, or other data capture modules.

The vLog module 302 is configured to capture data entries that are in a blog type format. As such, a vLog is a specialized blog used by the virtual persona system 102. In some embodiments, the vLog may be directly provided by the user to their life archive via their user device 106. In other embodiments, the vLog may be captured from the social networking source 108 or other external sources 110, as will be discussed below.

The messaging module 304 captures data entries from a messaging system. The messaging system may enable users of the virtual persona system 102 to communicate with each other. In one embodiment, the messaging system may comprise an internal chat system between users logged in with the virtual persona system 102.

The ask module 306 captures data entries from one or more users based on questions provided by the ask module 306. In exemplary embodiments, the ask module 306 accesses a database of questions and enables a user to input life archive data by answering these questions. In further embodiments, the ask module 306 may allow the user to add and/or modify questions used by the ask module 306.

The e-mail module 308 captures data entries in the form of e-mails. In exemplary embodiments, the e-mail module 308 receives e-mails from the user and extracts data from these e-mails. In other embodiments, the e-mail module 308 may monitor and capture e-mail communications to and from a user not directed or related to the virtual persona system 102. The exemplary e-mail module 308 may, in accordance with one embodiment, only allow e-mails from validated e-mail address. This allows for protection from spam.

In exemplary embodiments, the external source module 310 captures data entries that come from external sources, such as the social networking source 108 and other external sources 110. In some embodiments, the data entries may be pulled from these external sources. In other embodiments, the external sources may push data to the external source module 310. For example, the external source module 310 may capture postings by a user on Facebook and input the postings as life archive data entries. Further examples include capturing a user's iTunes playlist or Netflix movie queue as life archive data entries.

The exemplary teach module 312 enables a user to teach the virtual persona system 102 how to answer a user input or question from a user. For example, the user may ask his private virtual persona a question. The virtual persona system 102 will then return a response to the user. The response may comprise an answer to the question or a response indicating that the system doesn't have an answer to the question posed. If the user does not like the response provided by the virtual persona system 102, the user may use the teach module 312 to teach the virtual persona system 102 a different answer. The teach module 312 may enable the user to either correct the provided response or provide an answer if the virtual persona system 102 cannot provide a response.

In a further embodiment, the data capture engine 202 may comprise a template module 314. The template module 314 allows the user to select a base template that comprises life archive data that is true for the user. For example, a base template may exist for an individual that is born in California, joined the Air Force, and is now an engineer. Starting with the base template, the user will already have life archive data associated with him/her. The user may then revise or add more life archive data to the base template or augment the base template.

The data capture engine 202 of FIG. 3 is exemplary. Alternative embodiments may comprise more, less, or functionally equivalent combination of components and still be within the scope of exemplary embodiments.

Referring now to FIG. 4, a block diagram of an exemplary AI engine 210 is provided. The exemplary AI engine 210 is configured to coordinate interactions between the various users and the virtual persona system 102 in order to provide a virtual persona to the users. In exemplary embodiments, the AI engine 210 generates the AI files used to provide responses provided by the virtual persona. The AI engine 210 also receives requests for communication with the virtual persona, processes the requests, and provides the response in the form of a virtual persona. The exemplary AI engine 210 may comprise an AI file generator 402, a user interface module 404, an analysis module 406, and an output generator 408.

In exemplary embodiments, the AI file generator 402 creates artificial intelligence (AI) files using the tags assigned by the tagging engine 206 to the data entries. Similar to the tagging engine 208, the AI file creation may occur right after the data entry is tagged, at regularly scheduled intervals (e.g., every minute), or at any time the AI file generator 402 is directed to do so (e.g., manual instruction). The generated AI files may be stored in the life archive database 204. If the data entries are re-tagged, the AI file generator 402 may create new AI files using the new tags assigned to the re-tagged data entries. The exemplary AI file generator 402 creates AI files that are in a format that the AI engine 210 can quickly search and use to access data to be used to generate a requested virtual persona response. In one embodiment, the AI files comprise artificial intelligence markup language (AIML).

In accordance with exemplary embodiments, the AI files comprises one or more questions and their corresponding answers. The questions are created using the tags assigned by the tagging engine 206. The corresponding answers contain references to the data entries associated with the tags used to create the questions in the AI file. Continuing with the table tennis blog example, a question in an AI file may be “How is table tennis played?” The question may be created using the tags “table, “tennis,” and “play.” The corresponding answer to that question in the AI file may contain a reference to the table tennis blog (e.g., a link) in the life archive database 204. A typical AI file may contain one or more question and answer pairs. In exemplary embodiments, the AI file may be generated based on any number of data entries.

The user interface module 404 manages user interactions with the virtual persona system 102, and more specifically with a particular virtual persona. In accordance with exemplary embodiments, the user interface module 404 may provide a graphical interface through which the user may interact with the virtual persona system 102. The user may interact with the virtual persona system 102 via text input, audio input, visual input, or any combination thereof. Exemplary interactions with a virtual persona comprise asking the virtual persona questions or carrying on a conversation with the virtual persona.

Once a user input (e.g., question) is received through the user interface module 404, the analysis module 406 may analyze the AI files created by the AI file generator 402 for an appropriate response. Upon receipt of the question, the analysis module 406 may determine one or more keywords in the question. The analysis module 406 may then review every loaded AI file for the virtual persona for questions (e.g., keywords in the AI file) that may match the user input's keyword(s). If there is a match, the response (e.g., answer) from the relevant AI file(s) may be returned.

Based on the responses returned from the AI file(s) or lack of a response (if no match is found), the analysis module 406 may be configured to determine which one or more responses may be provided to the user. The response may comprise, for example, basic information directly from one or more of the AI files, a link to the virtual persona data entries associated with one or more of the AI files, the actual virtual persona data entries, themselves, and/or any combination thereof.

In exemplary embodiments, the virtual persona system 102 may comprise private, community, and generic AI files. Private AI files may be used by the AI engine 210 when the user is interacting with a private virtual persona associated with those particular private AI files. In contrast, community AI files may be used by the AI engine 210 when the user is interacting with a public virtual persona. In some embodiments, the community AI files may be associated with virtual persona data entries from a plurality of users (e.g., the community). Community AI files may also be used with a private virtual persona in some embodiments. Additionally, generic AI files may always be available to the AI engine 210. These generic AI files comprise questions and answers that are generally true for all users. For example, a user can ask a virtual persona “How many continents are there?” The answer to that question is the same for all virtual personas.

In some embodiments, the analysis module 406 may give different weights to the responses returned from AI file in order to determine which response(s) to provided. For example, the analysis module 406 may give higher priority to the private and community AI files over the generic AI files when providing answers to questions posed to the virtual persona. Similarly, the analysis module 406 may give higher priority to private AI files over community AI files. For example, if responses from a community AI file and a private AI file for the virtual persona are both returned by the analysis module 406, the analysis module 406 may select the private AI file. In a further example, if responses from two private AI files are returned with a first AI file comprising more instances of the keywords and tags than a second AI file, responses based on the first AI file may be selected.

The output generator 408 may then format that the response or answer for the user. In one embodiment, the output generator 408 may return a link to the relevant data entry or may provide the entire data entry, itself. For example, in the case of the table tennis blog, the output generator 408 may format a response having a link to the blog or may format a response providing the blog in its entirety. The output generator 408 may also provide the answer in an audio format, visual format, or a combination of both. For example, the output generator 408 may format the response as text for display on a monitor, as audio for output through speakers, or as an audio-visual combination displayed as a computer animation on a monitor with audio played through speakers. In some embodiments, the formatted response may be provided to the user via the user interface module 404.

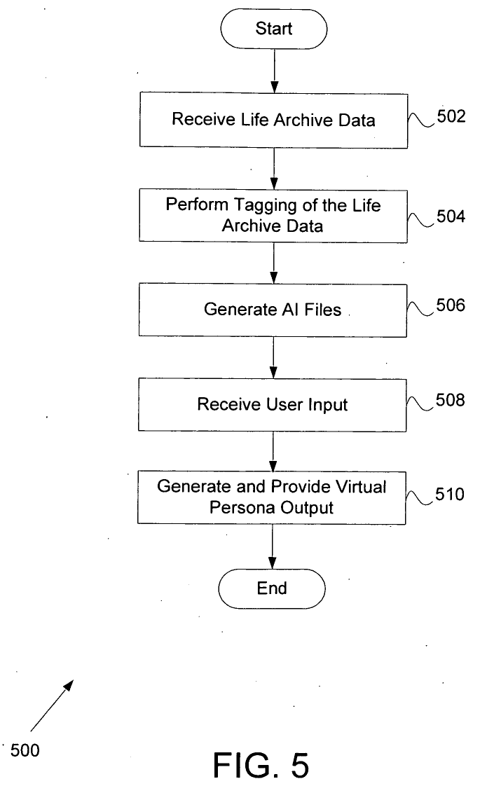

FIG. 5 is a flowchart 500 of an exemplary method for providing a virtual persona. In step 502, life archive data is received by the virtual persona system 102. In exemplary embodiments, the life archive data may be received by the data capture engine 202. The life archive data may be received from the user devices 106, the social networking sources 108, or other external sources 110. Examples of a life archive data entries include, for example, a blog or vLog, an email, or an instant messaging conversation.

In step 504, tagging of the life archive data is performed. Tagging of the life archive data comprises breaking down each life archive data entry into its keywords. In exemplary embodiments, the tagging engine 206 may perform tagging as the data is received, at regularly scheduled intervals, or at any time the tagging is desired. In one embodiment, the tagging method uses two lookup tables, one containing a list of nouns, and the other containing a list of verbs. Alternative embodiments may utilize any number of tables comprising any number of key items. Each data entry is then searched for the keywords in the lookup tables. In some embodiments, an algorithm may then be used to determine which keywords are to be used as the tags or metatags for that particular data entry.

In step 506, the AI files are generated. In exemplary embodiments, the AI file generator 402 generates the AI files using the tags assigned by the tagging engine 206 to the life archive data entries. The AI files are generated in a format that can be quickly searched and used to access the information referenced in the AI files.

In exemplary embodiments, the AI files comprise one or more questions and their corresponding answers. The questions are created using the tags assigned by the tagging of the life archive data. The corresponding answers comprise information from or references to the data entries associated with the tags used to create the questions in the AI file. For example, again using the data entry of a blog about table tennis, a question in an AI file may be associated with “How is table tennis played?” The question may be created using the tags “table, “tennis,” and “play.” The corresponding answer to that question in the AI file may comprise a reference to the blog about table tennis in the life archive database 204. A typical AI file may contain one or more question and answer pairs.

In step 508, the user input is received. The user input may be a question posed by the user to the virtual persona. In exemplary embodiments, the question may be received by the user interface module 404. In response, an AI virtual persona output is generated and provided in step 510.

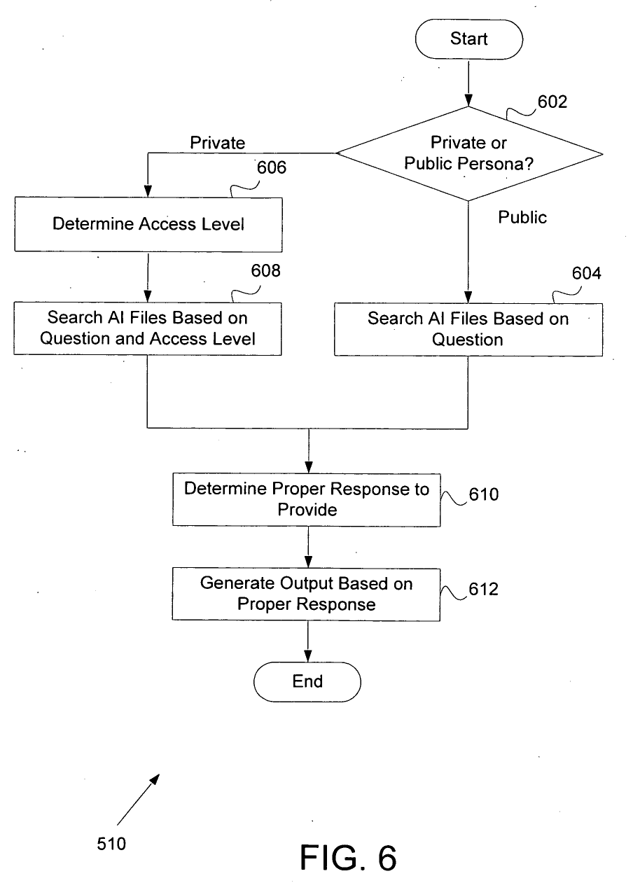

Referring now to FIG. 6, a flowchart of an exemplary method for generating and providing the virtual persona output (step 510) is illustrated. In step 602, a determination is made as to whether the virtual persona that is being interacted with is a private virtual persona or a public virtual persona. In some embodiments, the determination may be based on how the user accesses the virtual persona system 102. For example, if the user logs into their own account, the user may desire to interact with their personal private virtual persona. Alternatively, if the user reaches the virtual personal system 102 via a link or by invitation from a second user, the user may desire to interact with second user's private virtual persona. In other embodiments, the user may indicate to the virtual persona system 102 whether they want to interact with a private or public virtual persona (e.g., selection made on user interface).

If the interaction is with a public virtual persona, community and generic AI files may be searched based on the user input in step 604. In exemplary embodiments, the appropriate AI files may be loaded into memory prior to receipt of the user input in order to expedite the search process. Subsequently, the analysis module 406 may compare the user input (e.g., keywords in a question) with the AI files (e.g., keywords in the AI files) to determine if there are any matches.

If the interaction is with a private virtual persona, the user's access level is determined in step 606. Accordingly, if the user is interacting with their own private virtual persona, the user may have full access rights. However, if the user is interacting with another individual's private virtual persona, the user's access may be limited based on permissions granted by the other individual. These permissions may be set by the other individual and associated with one or both users' account and with the associated AI files.

In step 608, the private AI files are searched based on the question posed and the access level of the user. In some embodiments, only appropriate access level private AI files are loaded. Additionally, community and generic AI files may also be searched. In exemplary embodiments, the appropriate AI files may be loaded into memory prior to receipt of the user input in order to expedite the search process. Subsequently, the analysis module 406 will compare the user input (e.g., keywords in a question) with the AI files (e.g., keywords in the AI files) to determine one or more matches.

For both public and private personas, the method proceeds to step 610 in which a proper response is determined. If the AI files comprises a question or keywords similar to the question posed by the user, the proper response may be, for example, a corresponding answer listed in the AI file, a link to a data entry, or the data entry, itself. In embodiments where more than one response is found, weighting may be applied. For example, a response from a private AI file may be selected over a response from a community or generic AI file. If none of the AI files provide a response, the proper response may be a statement indicating that the virtual persona does not have an answer for the question asked.

In step 612, the output based on the proper response is generated. The output generated may be in an audio format, visual format, or a combination thereof. For example, the output generator 408 may provide the answer as text on a monitor, as audio through speakers, or as an audiovisual combination displaying a computer animation on a monitor with audio played through speakers.

It should be noted that the flowcharts of FIG. 5 and FIG. 6 are exemplary. Alternative embodiments may provide more, less, or functionally equivalent combination of steps. Additionally, the steps may be practiced in a different order.

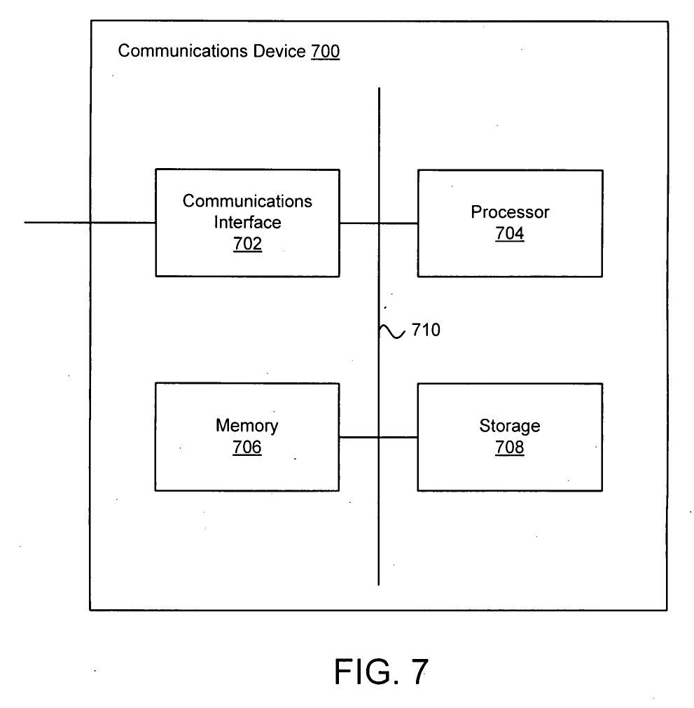

FIG. 7 is a block diagram of an exemplary computing device 700 that may be used. The computing device 700 may be used to run the virtual persona system 102 or be the user device 106. The computing device 700 comprises a communications interface 702, a processor 704, a memory 706, and storage 708, which are all coupled to a bus 710. The bus 710 provides communications between the communications interface 702, processor 704, memory 706, and storage 708. The processor 704 executes instructions, while the memory 706 permanently or temporarily stores data. Some examples of the memory 706 are RAM and ROM. The storage 708 may also permanently or temporarily stores data. Some examples of the storage 708 are hard disks and disk drives.

The embodiments of computing device 700 discussed herein are illustrative. As these embodiments are described with reference to illustrations, various modifications or adaptations of the methods and/or specific structures described may become apparent to those skilled in the art. The above-described components and functions can be comprised of instructions that are stored on a computer-readable storage medium. The instructions can be retrieved and executed by a processor. Some examples of instructions are software, program code, and firmware. Some examples of storage medium are memory devices, tape, disks, integrated circuits, and servers. The instructions are operational when executed by the processor to direct the processor to operate in accord with the invention. Those skilled in the art are familiar with instructions, processor(s), and storage medium.

While various embodiments have been described above, it should be understood that they have been presented by way of example only, and not limitation. For example, any of the elements associated with the virtual persona system 102 may employ any of the desired functionality set forth hereinabove. Thus, the breadth and scope of a preferred embodiment should not be limited by any of the above-described exemplary embodiments.

What is claimed is:

1. A method for providing a virtual persona, comprising:
receiving a user input directed to life archive data of a particular virtual persona;
determining at least one artificial intelligence file in response to the user input; and
providing an output based on the at least one artificial intelligence file to a user.

2. The method of claim 1 further comprising receiving and automatically tagging the life archive data for the particular virtual persona.

3. The method of claim 2 wherein receiving the life archive data comprises receiving one or more vLogs for the particular virtual persona.

4. The method of claim 2 wherein receiving the life archive data comprises receiving data from a coupled external source.

5. The method of claim 2 wherein receiving the life archive data comprises receiving answers to questions asked to one or more users.

6. The method of claim 2 wherein receiving the life archive data comprises receiving data from e-mails.

7. The method of claim 2 wherein receiving the life archive data comprises receiving data from a messaging system

8. The method of claim 2 wherein receiving the life archive data comprises receiving votes on life archive data.

9. The method of claim 1, further comprising generating the artificial intelligence files based at least on tags used for tagging life archive data.

10. The method of claim 1 further comprising loading artificial intelligence files for the particular virtual persona prior to receiving the user input.

11. The method of claim 1 wherein determining at least one artificial intelligence file comprises determining a level of access for the user.

12. The method of claim 1 wherein determining at least one artificial intelligence file comprises determining if the particular virtual personal is a private or public personal.

13. The method of claim 1 wherein providing the output to a user comprises generating a graphical interface to the output.

14. The method of claim 1 wherein providing the output to a user comprises generating an audio output.

15. A system for providing a virtual persona, comprising:
a user interface module configured to receive a user input directed to life archive data of a particular virtual persona;
an analysis module configured to determine at least one artificial intelligence file in response to the user input; and
an output generator configured to generate an output based on the at least one artificial intelligence file to a user.

16. The system of claim 15 further comprising a data capture engine configured to receiving the life archive data for the particular virtual persona.

17. The system of claim 15 further comprising a tagging engine configured to automatically tag the life archive data for the particular virtual persona.

18. The system of claim 16 further comprising a template generator configured to generate the artificial intelligence templates based at least on tags used for tagging life archive data.

19. The system of claim 16 further comprising an artificial intelligence editor configured to allow a user to edit life archive data for the particular virtual persona.

20. A machine readable medium having embodied thereon a program for providing instructions for a method for providing a virtual persona, the method comprising:
receiving a user input directed to life archive data of a particular virtual persona;
determining at least one artificial intelligence file in response to the user input; and
providing an output based on the at least one artificial intelligence file to a user.
